(19) United States
(12) Patent Application Publication
(10) Pub. No.: US 2009/0268547 A1
(43) Pub. Date: Oct. 29, 2009

(54) DEVICES, SYSTEMS AND METHODS FOR DRY POWDER PROCESSING

(75) Inventor: Dennis G. PARDIKES, Palos Park, IL (US)

Correspondence Address: ICE MILLER LLP, ONE AMERICAN SQUARE, SUITE 3100, INDIANAPOLIS, IN, 46282-0200, US

(73) Assignee: Norchem Industries, Mokena, IL (US)

(21) Appl. No.: 12/423,770

(22) Filed: Apr. 14, 2009

Related U.S. Application Data
(60) Provisional application No. 61/044,625, filed on Apr. 14, 2008.

(51) Int. Cl. B01F 15/02; B01F 13/00; B01F 15/04

(52) U.S. Cl. 366/172.1; 366/343

(57) ABSTRACT

Superfine powder particles (70-400 mesh, mean average) are wetted in a processing unit that disperses the powder by impact with an impeller before substantial contact with a solvent, such as water. The impeller is provided with posts that extend the dispersion zone above the impeller to capture and disperse any powder that may accumulate on the top of the impeller. The impeller is driven by a variable speed motor to adjust the rotational speed of the impeller to increase the efficiency of wetting. Processing may be adapted to wetting of other superfine materials, such as clays.

### RELATED APPLICATIONS

This U.S. Utility patent application claims priority to U.S. Provisional Patent Application Ser. No. 61/044,625, filed Apr. 14, 2008, which is hereby incorporated by reference in its entirety into this disclosure.

### BACKGROUND

The present invention relates to a processing system for solubilizing or hydrating dry particulate materials, such as polymers and clays, and, in particular, to a system for processing superfine particles.

Numerous manufacturing processes, such as those used in the water-treatment, paper and mining industries, use fillers and other additives in dry particle form that must first be solubilized or hydrated before being introduced into the manufacturing process. The process of solubilizing or hydrating superfine particulate materials in the size range of 70-400 mesh (mean average) has presented significant challenges. When the particles are too small, the wetting results are poor and insoluble agglomerations (fisheyes) form. For example, polymer manufacturers have gone to a great extent to remove the smaller particles (smaller than 70 mesh) during the manufacturing process to improve the wetting process. However, solubilization of these polymer preparations requires long dissolving and mixing times in the range of 30-120 minutes.

The prior art of processing superfine polymers involves the use of systems similar to my U.S. Pat. Nos. 5,599,101 and 5,879,080, herein incorporated by reference. Examples of such dry polymer processing systems are commercially available as Powdercat™ (Norchem Industries—Mokena, Ill.). They describe an apparatus for and methods of fully wetting each individual polymer particle.

In greater detail, a processing module with a rotor assembly receives the dry polymer flow and disperses it into an electrolyte such as water in a high shear state in order to achieve a maximum separation on impact with the rotor at the moment of wetting with an electrolyte. Then this mixture is immediately transferred to the mixing tank for further dissolution.

If properly wetted, all dry polymers act in the same manner. If the particle is small enough and can be wetted properly to eliminate agglomerations, the increase in surface area would allow the polymer to hydrate (dissolve) 30-120 times faster than typically sized polymer particles wetted by conventional processing methods.

An impediment to achieving this kind of superior performance has been the requirement for a device capable of properly handling and wetting superfine polymer particles.

### BRIEF SUMMARY

These needs and other needs are satisfied by a processing unit for hydrating dry polymers, comprising an impeller having a base and a plurality of posts extending above the base. A stream of dry polymer is dispersed by impact with the impeller before contact with a solvent. The impeller is driven by a variable speed motor, such that the rotational speed of the impeller may be adjusted to increase the efficiency of wetting of the dry polymer. In a preferred embodiment, a superfine dry polymer is used, having a mean average size range of between about 70-400 mesh. The processing unit may be adapted for use in hydration of other materials, such as clays.

In at least one embodiment, the impeller for processing a dry powder comprises a base and a plurality of posts extending above the base. Optionally, the impeller may additionally comprise one or more blades. In at least one embodiment of the impeller, the base of the impeller has a radius and each of the plurality of posts has a height of between about 0.25 and about 2.0 times the radius of the base. More specifically, each of the plurality of posts may have a height of between about 0.75 and about 1.25 times the radius of the base.

The impeller may be capable of rotating at various speeds. In at least one embodiment, the impeller for processing a dry powder rotates at speeds of about 7600 rpm or less. Further, the impeller may rotate at speeds of between about 3500 rpm to about 4500 rpm.

Embodiments of a system for processing a dry powder are also described herein. In at least one embodiment, a system for processing a dry powder comprises an impeller having a base and a plurality of posts extending above the base, a motor for rotating the impeller, a feeder for providing a stream of dry powder directly to the impeller, and a flow of solvent around the impeller. Optionally, the system for processing a dry powder may further comprise a metering pump configured to receive a stream of solubilized powder flowing from the flow of solvent.

The base of the impeller of the system may have a radius and each of the plurality of posts of the impeller may have a height of between about 0.25 to about 2.0 times the radius of the base. Optionally, each of the plurality of posts of the impeller may have a height of between about 0.75 to about 1.25 times the radius of the base. Further, in at least one embodiment of the system for processing a dry powder, the impeller may further comprise one or more blades.

The motor of the system for processing a dry powder may comprise a variable speed motor capable of rotating the impeller at speeds of about 7600 rpm or less. Further, the motor may be capable of rotating the impeller at speeds of between about 3500 rpm to about 4500 rpm. In addition, in the at least one embodiment of the system where the motor comprises a variable speed motor, the motor is capable of adjusting the speed at which the impeller rotates.

While the flow of solvent of the system may be provided in any manner, in at least one non-limiting example, the flow of solvent is provided by a weir. The flow of solvent of the system may cascade around the impeller. Additionally, the flow of solvent of the system may have a cascade point.

Where the flow of solvent of the system has a cascade point, each of the plurality of posts of the impeller may have a height such that each post is below the cascade point. In addition, in the at least one embodiment where the system further comprises a weir, the system may additionally comprise a removable collar for increasing the distance between the weir and the impeller.

In addition to the aforementioned, a method for processing dry powder particles is described herein. In at least one example, a method for processing dry powder particles comprises the steps of: providing an impeller having a base and a plurality of posts extending above the base; rotating the impeller; providing a flow of solvent around the impeller; and providing a stream of dry powder particles directly to the impeller, wherein the dry powder particles are dispersed by the impeller and then wetted by the solvent. In at least one additional embodiment, the above-described method may further comprise the step of mixing the wetted particles with a second solvent. Furthermore, certain embodiments of the method may be performed continuously and/or the wetted particles may be continuously introduced into a downstream process.

In at least one embodiment, the method of processing dry powder particles may further comprise the step of adjusting the rotational speed of the impeller to optimize the interaction between the impeller and the dry powder particles. Further, the impeller provided in the method may rotate at a speed of about 7600 rpm or less. Optionally, the impeller may rotate at a speed of between about 3500 rpm to about 4500 rpm.

The dry powder particles processed using the described method may comprise polymer particles having a mean average size of about 70 to about 400 mesh. Alternatively, the dry powder processed using the described method may comprise a superfine clay.

### BRIEF DESCRIPTION OF THE DRAWINGS

FIG. 1 is a schematic diagram of a prior art system for processing conventional dry polymer.

FIG. 2 is a perspective section view of a prior art processing unit for solubilizing or hydrating conventional dry polymer.

FIG. 3 is a perspective section view of processing unit for processing superfine dry polymer.

FIG. 4 is a detail perspective view of the impeller shown in the apparatus of FIG. 3.

FIG. 5 is a schematic diagram of a system for processing superfine dry polymer incorporating the processing unit of FIG. 3.

### DETAILED DESCRIPTION

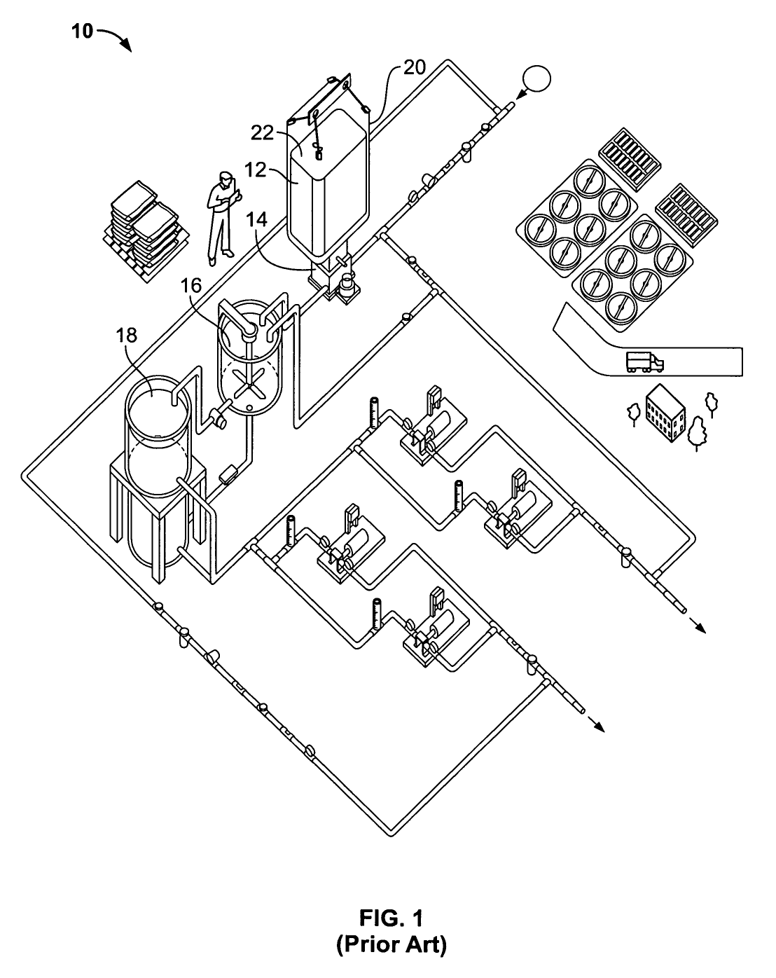

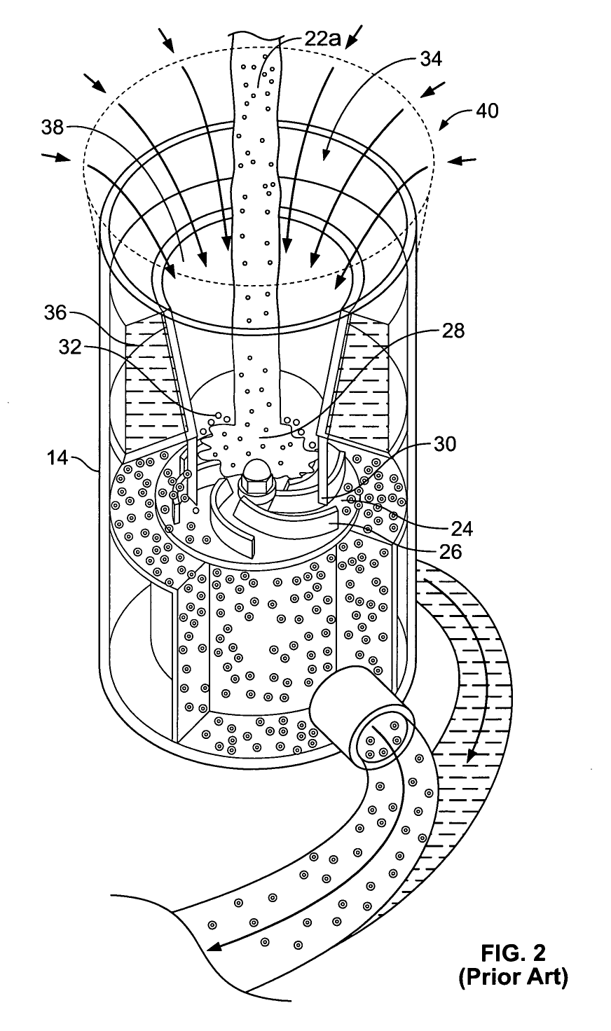

Referring to FIGS. 1 and 2, a prior art system 10 for processing conventional dry polymer is shown, comprising a feeder 12 for the dry polymer, a dry polymer processing unit 14, a mixing tank 16 and a holding tank 18. Feeder 12 typically comprises a hopper 20 containing the bulk dry polymer 22, which is fed into processing unit 14 as a stream 22a of dry polymer. In a preferred embodiment, feeder 12 is a volumetric feeder, such as a single screw feeder, to provide a consistent flow of dry polymer to processing unit 14.

Processing unit 14 comprises an impeller 24 that is provided with blades 26 and is driven by a fixed speed motor (not shown). Dry polymer stream 22a is fed directly into a dispersion zone 28 where the polymer particles are separated and accelerated by impact with blades 26 of impeller 24. The dispersed polymer enters the wetting zone 30 where the polymer particles are surrounded and penetrated by contact with a moving stream of water 32.

The opening 34 of processing unit 14 is surrounded by a weir 36 that provides a flow of water 38 that cascades into the processing unit 14 and captures any stray particles from dry polymer stream 22a. The flow of water 38 also induces a flow of air into processing unit 14 that further carries stray particles from dry polymer stream 22a into the processing unit 14.

The wetted polymer is fed from a mixing zone in processing unit 14 into a mixing tank 16 where the process of solubilization (hydration) continues. After a period of time, the polymer solution is transferred into a storage tank 18 from which it may be introduced into a downstream process.

At lower feed rates, the stream of dry polymer 22a reaches the impeller blades 26 and the particles are dispersed and cleared from the impeller 24 continuously. However, in higher polymer feed rate conditions, the impeller blades 26 do not clear the polymer fast enough before a layer of polymer momentarily accumulates on top of the impeller 24. The formation of a layer of dry polymer on top of the impeller blades 26 is known as loading. This layer of dry polymer is not dispersed, but sloughs off of the impeller 24 due to centrifugal forces, thereby forming a mass of dry polymer particles and resulting in a partially wetted polymer.

It has been discovered that loading of the dry polymer on top of the impeller can be prevented by modifying the rotor (impeller) configuration and rotational speed. The addition of posts to the impeller circumference with an accompanying increase in speed of the polymer processing module (“PPM”) motor provides increased wetting efficiency, particularly with superfine polymers having a size of more than about 70 mesh, and increased wetting capacity. These design changes enable an operator to choose the most optimal motor RPM (and subsequent speed of the impeller) based on the quantity of dry polymer (dry weight) to be processed and/or the mesh size of the dry polymer particle. For example, and without limitation, an operator may adjust the rotational motor RPM to achieve a 99% wetting efficiency rating.

Conventional processes use a fixed speed motor at approx 3450 rpm. The use of an AC variable frequency drive in connection with the motor allows the speed to be infinitely adjustable between about 0-7600 RPM. In a preferred embodiment, the motor speed will range from about 3500 RPM to about 4500 RPM.

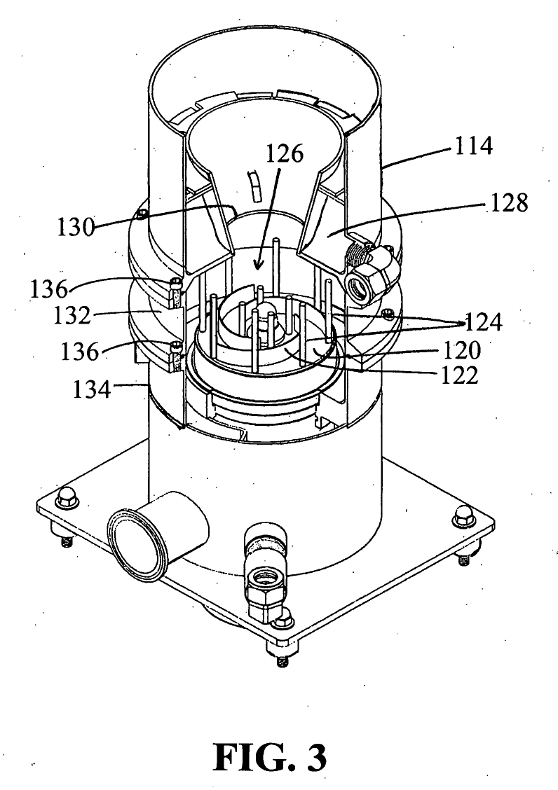

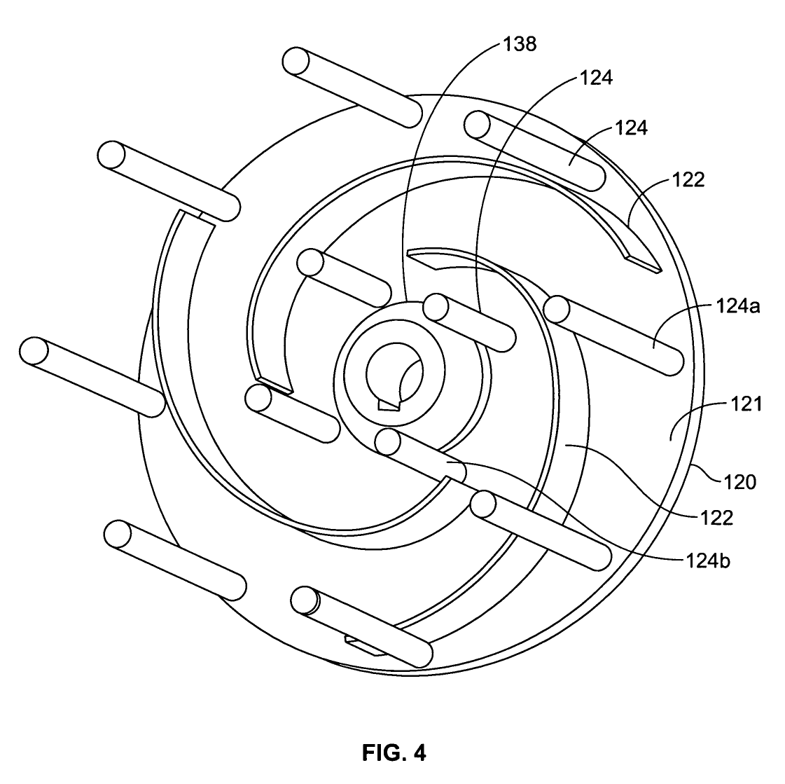

Now referring to FIGS. 3 and 4, a dry polymer processing unit 114 is shown that includes an impeller 120 that has blades 122 and posts 124. As shown in FIGS. 3 and 4, posts 124 extend the mechanical “dispersion zone” above the base of the impeller 120. Accordingly, the posts 124 extend the “high shear zone” above impeller 120 to process the layer of powder that momentarily forms on top of the impeller blades 122 during the higher polymer feed rate conditions. In this manner, posts 124 extend the mechanical “dispersion zone” above impeller 120, thereby capturing the top layer of powder and dispersing it properly before wetting.

The addition of posts 124 to, impeller 120 has been found to improve processing of dry polymer by about 25-30% over conventional processing systems. For example, when a stream of 200 mesh PEO (polyethylene oxide) is fed into a conventional dry polymer processing system at a rate of 3000 g/min, only approximately 75% of the polymer reaches the impeller blades before dispersion/wetting. The remaining 25% sloughs off and goes through relatively untouched by the impeller.

When a system having posts extending from the base of the impeller is used, the addition of the posts provides the added processing energy above the blades to address the loading issues. The combination post/blade (hybrid) design now has about a 99% wetting efficiency rating. In at least one embodiment, the height of the wetting chamber 126 of the dry polymer processing unit 114 is increased to allow for adequate clearance under the weir 128 for the height of posts 124. In this manner, the posts 124 remain underneath and below the weir cascade point 130. For example and without limitation, polymer processing unit 114 may additionally comprise a removable collar 132 to increase the separation between weir 128 and mixing chamber 134 to provide clearance for the height of posts 124. Removable collar 132 may be secured to weir 128 and/or mixing chamber 134 by bolts 136, or by other means known in the art.

The addition of posts 124a to the outer circumference of impeller 120 should extend above the impeller base 121 equal to about 0.25-2.0 times the radius of the impeller. The preferred range of height of posts 124a is about 0.75 to about 1.25 times the radius of the impeller 120. For example, in at least one embodiment, for an impeller 120 having a radius of 2 inches, each post 124a may be between about 1.6 and about 2.5 inches in length. The height of weir 128 above impeller 120 will be commensurately increased by about 2.5 inches to accommodate the height of posts 124.

The number of posts 124 on impeller 120 can vary depending on the type of polymer processed by the dry polymer processing unit 114, with the impeller 120 comprising a minimum of two posts 124 and a maximum limited only by the spacing between the posts 124 required to allow the wetted polymer to pass through unobstructed. Theoretically, an impeller 120 may have any number of posts—e.g., 2, 3, 4, 5, 6, 7, 8, 9, 10, 11, 12, 13, 14, etc. In at least one embodiment, an impeller 120 having a 2 inch radius comprises eight posts 124. In addition, the diameter and/or shape of the posts 124 may be modified. While the posts 124 are illustrated as having a cylindrical configuration in FIGS. 3 and 4, it will be appreciated that the top of each of the posts 124 may comprise any configuration (e.g., rounded, tapered, etc.).

In at least one alternative embodiment, posts 124b may be positioned close to the center hub 138 of impeller 120 to aid in dispersing and wetting of the polymer. The length and number of these “inner posts” 124b preferably follows the formula for the outer circumference posts 124a. Additionally, the heights of the various posts 124 may vary. For example and without limitation, the inner posts 124b may be generally shorter than the posts 124a on the outer circumference of the impeller 120.

In at least one additional embodiment, impeller blades 122 may be eliminated altogether, leaving only the posts 124 attached to impeller base 121. In yet another at least one embodiment, posts 124 may be positioned in groups as opposed to posts with uniform distances between them.

Those of skill in the art will appreciate that non-polymeric materials may also be processed. For example, Bentonite is a dry clay substrate used in paper making, oil field drilling, food and pharmaceutical industries. Bentonite is classified as a superfine powder in the 300-400 mesh size range. The Bentonite clay requires wetting to create a slurry suspension. Different from polymers, the slurry is generally 5-20 times more concentrated than polymer solutions. A typical Bentonite slurry will be in a concentration range of about 3-6% whereas polymer solutions are typically in the range of about 0.1-0.3%.

The higher concentration of Bentonite slurries requires wetting rates that are much higher than typically required for the processing of superfine polymers. The addition of faster motor speeds and extended shear zone impeller design virtually eliminates and greatly enhances the ability to create a Bentonite slurry that immediately exits the processing module almost fully hydrated. We estimate the hydration time for the slurry to be reduced 2-12 times over conventional wetting systems.

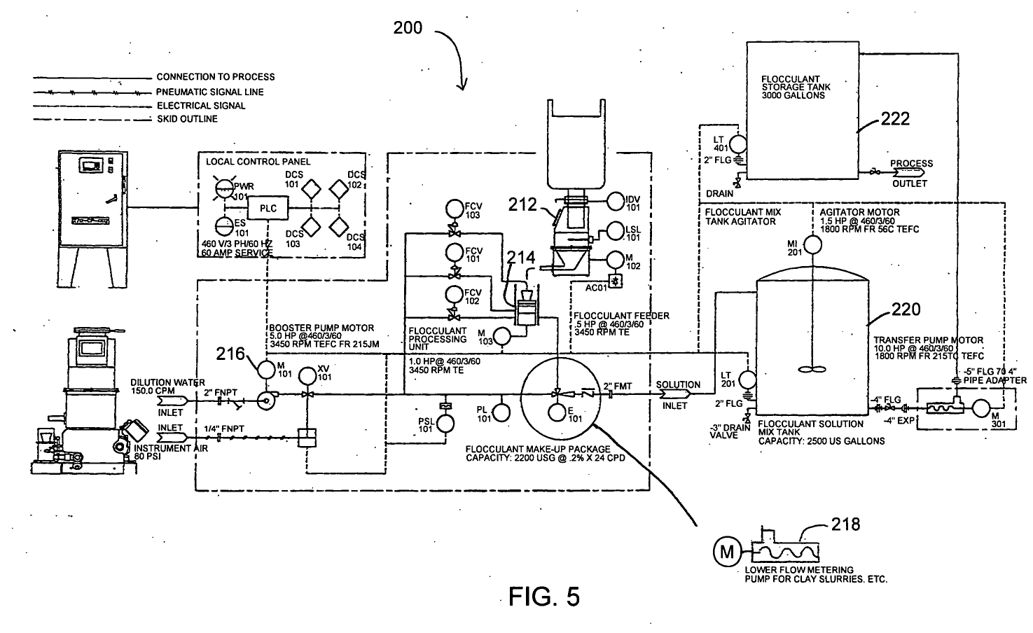

Referring to FIG. 5, a system 200 for processing dry polymer is shown that comprises a feeder 212 for the dry polymer and a dry polymer processing unit 214 which includes an impeller (not shown) that has posts as described above with respect to impeller 120. When superfine dry polymer is used, processing unit 214 provides a continuous output of solubilized polymer which may be introduced directly into a downstream process. In an alternative embodiment, additional water or solvent may be mixed with the output via a pump motor 216, to dilute the polymer solution. Where system 200 is used for hydration of Bentonite or similar materials that produce a slurry, a metering pump 218 may be provided to facilitate handling of the processed slurry.

Although the output of processing unit 214 is typically fully solubilized or hydrated and is produced continuously, in some cases, the output may be fed into an optional mixing tank 220 and/or storage tank 222 before being introduced into a downstream process. An intermediate mixing tank 220 and/or storage tank 222 provides an additional reserve against the temporary interruption of system 200, such as when feeder 212 is empty.

It will be apparent to those of skill in the art that changes and modifications may be made in the embodiments illustrated herein, without departing from the spirit and scope of the invention.

1. An impeller for processing a dry powder comprising:
a base; and
a plurality of posts extending above the base.

2. The impeller of claim 1, wherein the impeller further comprises one or more blades.

3. The impeller of claim 1, wherein the base of the impeller has a radius and each of the plurality of posts has a height of between about 0.25 and about 2.0 times the radius of the base.

4. The impeller of claim 1, wherein the impeller rotates at speeds of about 7600 rpm or less.

5. The impeller of claim 4, wherein the impeller rotates at speeds of between about 3500 rpm to about 4500 rpm.

6. The impeller of claim 1, wherein the base of the impeller has a radius and each of the plurality of posts has a height of between about 0.75 and about 1.25 times the radius of the base.

7. The impeller of claim 1, wherein at least one of the plurality of posts has a first height, at least one of the plurality of posts has a second height and the first height is shorter than the second height.

8. The impeller of claim 1, wherein each of the plurality of posts comprises a cylindrical configuration.

9. A system for processing a dry powder comprising:
an impeller having a base and a plurality of posts extending above the base;
a motor for rotating the impeller;
a feeder for providing a stream of dry powder directly to the impeller; and
a flow of solvent around the impeller.

10. The system of claim 9, wherein the base of the impeller has a radius and each of the plurality of posts of the impeller has a height of between about 0.25 to about 2.0 times the radius of the base.

11. The system of claim 9, wherein the motor comprises a variable speed motor that is capable of rotating the impeller at speeds of about 7600 rpm or less.

12. The system of claim 11, wherein the speed of the motor is infinitely adjustable.

13. The system of claim 11, wherein the motor is capable of rotating the impeller at speeds of between about 3500 rpm to about 4500 rpm.

14. The system of claim 9, wherein the base of the impeller has a radius and each of the plurality of posts of the impeller has a height of between about 0.75 to about 1.25 times the radius of the base.

15. The system of claim 9, wherein the flow of solvent cascades around the impeller and has a cascade point, each of the plurality of posts of the impeller having a height that is below the cascade point.

16. The system of claim 9, wherein at least one of the plurality of posts has a first height, at least one of the plurality of posts has a second height and the first height is shorter than the second height.

17. The system of claim 15, wherein the flow of solvent is provided by a weir and the system further comprises a removable collar for increasing the distance between the weir and the impeller.

18. The system of claim 9, wherein the impeller further comprises one or more blades.

19. The system of claim 9, further comprising a metering pump configured to receive a stream of solubilized powder flowing from the flow of solvent.

20. The system of claim 9, wherein each of the plurality of posts of the impeller comprises a cylindrical configuration.

21. A method for processing dry powder particles comprising the steps of:
providing an impeller having a base and a plurality of posts extending above the base;
rotating the impeller;
providing a flow of solvent around the impeller; and
providing a stream of dry powder particles directly to the impeller, wherein the dry powder particles are dispersed by the impeller and then wetted by the solvent.

22. The method of claim 21, wherein the impeller rotates at a speed of about 7600 rpm or less.

23. The method of claim 22, wherein the impeller rotates at a speed of between about 3500 rpm to about 4500 rpm.

24. The method of claim 22, further comprising the step of adjusting the rotational speed of the impeller to optimize the interaction between the impeller and the dry powder particles.

25. The method of claim 22, wherein the steps of the method are performed continuously.

26. The method of claim 25, wherein the wetted particles are continuously introduced into a downstream process.

27. The method of claim 21, wherein the dry powder comprises polymer particles having a mean average size of about 70 to about 400 mesh.

28. The method of claim 21, wherein the dry powder comprises a superfine clay.

29. The method of claim 21, wherein the method further comprises the step of mixing the wetted particles with a second solvent.
